(19) United States
(12) Patent Application Publication
(10) Pub. No.: US 2010/0286323 A1
(43) Pub. Date: Nov. 11, 2010

(54) METAL FINE PARTICLE-DISPERSING AGENT COMPOSED OF POLYMER COMPOUND HAVING DITHIOCARBAMATE GROUP

(75) Inventors: Kei Yasui, Funabashi-shi (JP); Masaaki Ozawa, Funabashi-shi (JP)

Correspondence Address: OLIFF & BERRIDGE, PLC, P.O. BOX 320850, ALEXANDRIA, VA, 22320-4850, US

(73) Assignee: NISSAN CHEMICAL INDUSTRIES, LTD., TOKYO (JP)

(21) Appl. No.: 12/675,999

(22) PCT Filed: Sep. 3, 2008
(86) PCT No.: PCT/JP2008/065907

§ 371 Date: Jun. 28, 2010

(30) Foreign Application Priority Data
Sep. 3, 2007 (JP) 2007-228209

(51) Int. Cl. C08K 3/08; C08L 41/00

(52) U.S. Cl. 524/440; 524/439

(57) ABSTRACT

There is provided a metal fine particle-dispersing agent for forming a dispersion system of metal fine particles. A metal fine particle-dispersing agent comprises a branched and/or linear polymer compound having a dithiocarbamate group and having a weight average molecular weight of 500 to 5,000,000. The branched and/or linear polymer may be a branched polymer of the formula (1) or a linear polymer represented by the formula (4).

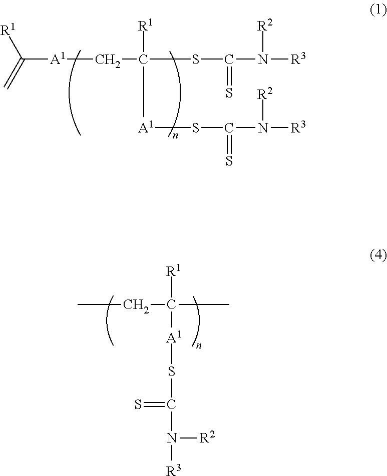

### TECHNICAL FIELD

The present invention relates to a dispersing agent for dispersing metal fine particles in a polymer, and to a composition containing the dispersing agent and metal fine particles.

### BACKGROUND ART

Metal fine particles having a particle size of about several nanometers to several ten nanometers show various physical and chemical properties which are different from those of bulk metals. For example, it has been traditionally known as an optical property that a unique coloring is exhibited according to the species and size of a metal by a color development mechanism called as plasmon absorbance, and solutions of metal fine particles have been used for colorants such as paints. In addition, applications to electroconductive pastes, transparent electroconductive films, high density recording materials, light shielding filters, chemical sensors, catalysts and the like have been extended.

As a method for preparing such metal fine particles, a gas phase method and a liquid phase method may be exemplified, and the liquid phase method may provide more easily good fine particles having a narrow particle size distribution at low costs. Generally, in the liquid phase method, preparation is carried out by reducing a metal ion with a reducing agent in a metal salt solution to which an organic dispersing agent having an affinity for a metal has been added. Typical examples of the dispersing agent include citric acid, surfactants, low molecular compounds having a thiol group or an amino group, and polymers such as polyvinyl pyrrolidone.

Patent Document 1 and Non-patent Document 1 show methods for preparing metal fine particles using a thiol compound. Since the surfaces of the thus-obtained metal fine particles are strongly coated with the thiol compound, the particles may be recovered as a powder and may be dispersed again in a solvent. Furthermore, Non-patent Document 2 shows a method for preparing metal fine particles which are coated with a low molecular compound having a dithiocarbamate group. Thus, since a compound having functional groups containing sulfur atoms has a high affinity for the surface of a metal, it shows an excellent property as a dispersing agent for metal fine particles.

It is considered that when such metal fine particles are used as a material, the fine particles are not used solely but as a dispersion in a resin in many cases. Therefore, the dispersing property of the metal fine particles in a polymer is a very important factor. However, there is no example in which the dispersing property of these metal fine particles stabilized with a sulfur-containing compound in a polymer is evaluated. Furthermore, there is no example in which metal fine particles are stabilized with a dispersing agent composed of a polymer compound having a dithiocarbamate group.

Patent Document 1: Japanese Patent Application Publication No. JP-A-2003-193118

Non-patent Document 1: Journal of Chemical Society, Chemical Communication, p. 801 (1994)

Non-patent Document 2: Journal of the American Chemical Society, No. 127, p. 7328 (2005)

### DISCLOSURE OF THE INVENTION

### Problems to be Solved by the Invention

It is an object of the present invention to provide a metal fine particle-dispersing agent for dispersing metal fine particles in a polymer having an excellent dispersibility, namely, a dispersing agent composed of a polymer compound having a dithiocarbamate group. It is another object of the present invention to provide a composition containing the metal fine particle-dispersing agent and metal fine particles.

### Means for Solving the Problems

The inventors have done intensive studies so as to achieve the above-mentioned objects, and consequently found that a branched and/or linear polymer having N,N-dialkyldithiocarbamate group as a functional group on the end of the molecule is useful as a dispersing agent for metal fine particles.

Furthermore, they have found that, when a hyperbranched polymer is used as a dispersing agent for metal fine particles in the present invention, the hyperbranched polymer exhibits a high affinity for the metal surface and consequently exhibits an excellent dispersing property as a dispersing agent for metal fine particles by providing a dithiocarbamate group as a functional group on the end group of the hyperbranched polymer.

Namely, the present invention relates to:

according to a first aspect, a metal fine particle-dispersing agent for forming a dispersion system of metal fine particles, comprising a branched and/or linear polymer compound having a dithiocarbamate group and having a weight average molecular weight of 500 to 5,000,000;
according to a second aspect, a composition containing the metal fine particle-dispersing agent of the first aspect and metal fine particles;
according to a third aspect, the composition of the second aspect, wherein the dithiocarbamate group of the metal fine particle-dispersing agent adheres to the metal fine particles to form a complex;
according to a fourth aspect, the composition of the second or third aspect further comprising an organic solvent;
according to a fifth aspect, the composition of the fourth aspect, wherein the metal fine particles are dispersed in the organic solvent;
according to a sixth aspect, composition of the fourth aspect, wherein the complex is dispersed in the organic solvent;
according to a seventh aspect, the composition of any one of the second to sixth aspects, wherein the metal fine particles are at least one selected from the group consisting of scandium, titanium, vanadium, chromium, manganese, iron, cobalt, nickel, copper, zinc, gallium, germanium, yttrium, zirconium, niobium, molybdenum, ruthenium, rhodium, palladium, silver, cadmium, indium, tin, antimony, hafnium, tantalum, tungsten, rhenium, osmium, iridium, platinum, gold, mercury, thallium and bismuth;
according to an eighth aspect, the composition of the seventh aspect, wherein the metal fine particles are at least one selected from the group consisting of gold, silver, platinum, copper, nickel, ruthenium, rhodium, palladium, osmium and iridium;
according to a ninth aspect, the composition of the eighth aspect, wherein the metal fine particles are at least one selected from the group consisting of gold, silver, platinum and copper;
according to a tenth aspect, a thin film obtained from the composition of any one of the second to ninth aspects;
according to an eleventh aspect, the metal fine particle-dispersing agent of the first aspect, wherein the metal fine particle-dispersing agent is a branched polymer represented by the formula (1):

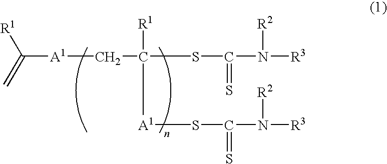

wherein
R¹ represents a hydrogen atom or a methyl group,
R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom,
A¹ represents the formula (2) or (3):

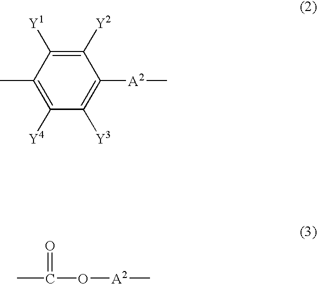

wherein
A² represents a linear, branched or cyclic alkylene group having 1 to 30 carbon atoms optionally containing an ether bond or an ester bond,
Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group, and
n represents the number of repeating unit structures and represents an integer of 2 to 100,000;
according to a twelfth aspect, the metal fine particle-dispersing agent of the first aspect, wherein the metal fine particle-dispersing agent is a linear polymer represented by the formula (4):

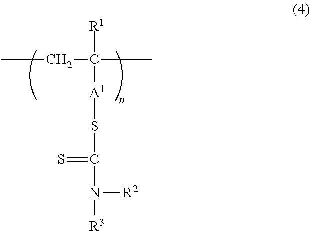

wherein
R¹ represents a hydrogen atom or a methyl group,
R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom,
A¹ represents the formula (5) or (6):

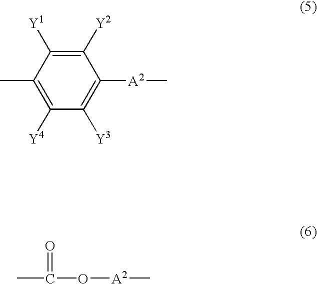

wherein
A² represents a linear, branched or cyclic alkylene group having 1 to 30 carbon atoms optionally containing an ether bond or an ester bond,
Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group, and
n represents the number of repeating unit structures and represents an integer of 2 to 100,000;
according to a thirteenth aspect, the composition of the second aspect, wherein the metal fine particle-dispersing agent is the branched polymer represented by the formula (1);
according to a fourteenth aspect, the composition of the second aspect, wherein the metal fine particle-dispersing agent is the linear polymer represented by the formula (4); and
according to a fifteenth aspect, a method for producing the composition of the second aspect, which includes mixing the metal fine particle-dispersing agent with a metal salt, and reducing the metal salt in the mixture with a reducing agent.

### EFFECT OF THE INVENTION

The metal fine particles dispersed in the polymer having a dithiocarbamate group of the present invention may be collected as a powder, and do not show aggregation and are stable under an ordinary temperature and an ordinary pressure. Furthermore, they may be readily re-dispersed in an organic solvent. Moreover, when they are dispersed in a resin such as polystyrene, they are not aggregated and may be dispersed in the form of primary particles as they are, as compared to metal fine particles which are stabilized with a conventional alkylthiol.

At this time, the dithiocarbamate group of the metal fine particle-dispersing agent adheres to the metal fine particles to form a complex, and the metal fine particles in the complex are composed of a metal nucleus having a particle size in the range of from 3 to 5 nm.

### BEST MODE FOR CARRYING OUT THE INVENTION

The metal fine particles which are used in the present invention are not specifically limited, and examples thereof may include scandium, titanium, vanadium, chromium, manganese, iron, cobalt, nickel, copper, zinc, gallium, germanium, zirconium, niobium, molybdenum, ruthenium, rhodium, palladium, silver, cadmium, indium, tin, antimony, hafnium, tantalum, tungsten, rhenium, osmium, iridium, platinum, gold, mercury, thallium and bismuth, and these metals may be one kind or an alloy of two or more kinds. Preferable examples may include gold, silver, platinum, copper, nickel, ruthenium, rhodium, palladium, osmium and iridium. More preferable examples may include gold, silver, platinum and copper. The metal fine particles may be obtained by adding a reducing agent to an aqueous solution of a metal salt to reduce a metal ion. Examples of the metal salt may include chloroauric acid, silver nitrate, copper sulfate, copper nitrate, platinum (II) chloride, Pt(dba)₂ [dba=dibenzylideneacetone], Pt(cod)₂ [cod=1,5-cyclooctadiene], PtMe₂ (cod), palladium chloride, palladium acetate, palladium nitrate, Pd₂(dba)₃ (CHCl₃), Pd(dba)₂, rhodium chloride, rhodium acetate, ruthenium chloride, ruthenium acetate, Ru(cod)(cot) [cot=cyclooctatriene], iridium chloride, iridium acetate, Ni(cod)₂ and the like.

Examples of the method for reducing the metal ion may include a method including irradiating light with a high pressure mercury lamp, a method including adding a compound having a reducing effect, and the like. Of these, the method including adding a compound having a reducing effect is advantageous in the production since specific apparatuses are not required.

As the compound having a reducing effect, various conventionally-used ones used as reducing agents may be used. For example, borohydrides of alkali metals such as sodium borohydride, hydrazine compounds, citric acid or salts thereof, succinic acid or salts thereof, ascorbic acid or salts thereof, and the like, which have been conventionally used as reducing agents, may be used.

The amount of the reducing agent to be added is preferably from 1 to 50 mol with respect to 1 mol of the metal ion. When the amount is lower than 1 mol, the reduction is not sufficiently carried out, and when the amount exceeds 50 mol, stability against aggregation is decreased. More preferably, the amount is from 1.5 to 10 mol.

Examples of the polymer having a dithiocarbamate group which is used as the dispersing agent for the metal fine particles of the present invention may include one represented by the formula (1). In the formula (1), R¹ represents a hydrogen atom or a methyl group. R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom. Then represents a number of the repeating unit structures and represents an integer of from 2 to 100,000. A¹ represents a structure represented by the formula (2) or (3). In the formulas (2) and (3), A² represents a linear, branched or cyclic alkylene group having 1 to 30 carbon atoms optionally containing an ether bond or an ester bond, and Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group.

Alternatively, examples of the polymer having a dithiocarbamate group which is used as the dispersing agent for the metal fine particles of the present invention may include one represented by the formula (4). In the formula (4), R¹ represents a hydrogen atom or a methyl group. R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom. The n represents the number of repeating unit structures and represents an integer of 2 to 100,000. A¹ represents a structure represented by the formula (5) or (6). In the formulas (5) and (6), A² represents a linear, branched or cyclic alkylene group having 1 to 30 carbon atoms optionally containing an ether bond or an ester bond, and Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group.

Examples of the specific examples of the alkylene group may include linear alkylene groups including a methylene group, an ethylene group, an n-propylene group, an n-butylene group, an n-hexylene group and the like, and branched alkylene groups including an isopropylene group, an isobutylene group, a 2-methylpropylene group and the like. Examples of the cyclic alkylene group may include alicyclic aliphatic groups having a monocyclic, polycyclic or crosslinked-cyclic cyclic structure having 3 to 30 carbon atoms. Specific examples may include groups having monocyclic, bicyclic, tricyclic, tetracyclic, pentacyclic structures and the like having 4 or more carbon atoms. Examples of the alkyl group having 1 to 20 carbon atoms may include a methyl group, an ethyl group, an isopropyl group, a cyclohexyl group, an n-pentyl group and the like. Examples of the alkoxy group having 1 to 20 carbon atoms may include a methoxy group, an ethoxy group, an isopropoxy group, a cyclohexyloxy group, an n-pentyloxy group and the like. Examples of the halogen atom are a fluorine atom, a chlorine atom, a bromine atom and an iodine atom. As Y¹, Y², Y³ and Y⁴, a hydrogen atom or an alkyl group having 1 to 20 carbon atoms is preferable.

The polymer having a dithiocarbamate group which is used as the dispersing agent for the metal fine particles of the present invention has a weight average molecular weight Mw which is measured by polystyrene conversion by gel permeation chromatography of 500 to 5,000,000, or 1,000 to 1,000,000, or 2,000 to 500,000, or from 3,000 to 200,000. Furthermore, the degree of distribution Mw (weight average molecular weight)/Mn (number average molecular weight) is 1.0 to 7.0, or 1.1 to 6.0, or 1.2 to 5.0.

The amount of the dispersing agent to be added is preferably 50 to 2,000 parts by mass with respect to 100 parts by mass of the metal ion. When the amount is lower than 50 parts by mass, the dispersibility of the metal fine particles is insufficient, and when the amount exceeds 2,000 parts by mass, the content of organic substances increases and the physical property and the like tend to be deteriorated. More preferably, the amount is 100 to 1,000 parts by mass.

### EXAMPLES

Hereinafter, the present invention is described in more detail with referring to the following examples. However, the present invention is not limited to only these examples.

### Reference Example 1

### Synthesis of N,N-Diethyldithiocarbamylmethylstyrene

120 g of chloromethylstyrene [manufactured by Seimi Chemical Co., Ltd., CMS-14 (trade name)], 181 g of sodium N,N-diethyldithiocarbamate trihydrate [manufactured by Kanto Chemical Co., Inc.] and 1,400 g of acetone were charged into a 2 L reaction flask, and reacted at 40° C. for 1 hour under stirring. After the reaction, the precipitated sodium chloride was removed by filtration, and acetone was then distilled off from the reaction solution using an evaporator to give a crude reaction powder. The crude reaction powder was dissolved again in toluene and separated in a toluene/water system, and the objective product was recrystallized from the toluene layer in a refrigerator at −20° C. The recrystallized product was filtered and dried in vacuo to give 206 g of the objective product in the form of a white powder (yield 97%). The purity (area percentage) obtained by liquid chromatography was 100%. Melting point 56° C.

### Reference Example 2

### Synthesis of Styrene-Based Hyperbranched Polymer Having Dithiocarbamate Groups at Ends of Molecule

108 g of N,N-diethyldithiocarbamylmethylstyrene and 72 g of toluene are charged into a 300 mL reaction flask and stirred to prepare a pale yellow transparent solution, and the reaction system was purged with nitrogen. A 100 W high pressure mercury lamp [HL-100, manufactured by Sen Lights Co., Ltd] was activated from the center of the solution, and a photopolymerization reaction by internal irradiation was carried out at room temperature for 12 hours under stirring.

The reaction liquid was then added to 3,000 g of methanol to reprecipitate the polymer in the form of a mass having a high viscosity, and the supernatant was removed by decantation. The polymer was further dissolved in 300 g of tetrahydrofuran, and the solution was added to 3,000 g of methanol to reprecipitate the polymer in the form of a slurry. The slurry was filtered and dried in vacuo to give 48 g of the objective product in the form of a white powder. The weight average molecular weight Mw measured by polystyrene conversion by gel permeation chromatography was 20,900, and the degree of distribution Mw/Mn was 4.9. In an elemental analysis, carbon was 64.6%, hydrogen was 7.4%, nitrogen was 5.0% and sulfur was 25.3%. According to thermogravimetry, the 5% weight loss temperature was 248° C.

### Example 1

### Preparation of Gold Fine Particles Using Branched Polymer

0.5 g of the branched polymer represented by the following formula (7) which was synthesized in Reference Example 2 was dissolved in 200 mL, of a tetrahydrofuran (THF) solution, and 6.7 mL of a 30 mM aqueous solution of chloroauric acid was added thereto. 10 mL of a 0.1 M aqueous solution of sodium borohydride was then added dropwise over about 5 minutes. The solution turned into brown according to the dropwise addition. Stirring was carried out for 30 minutes, and thereafter THF was distilled off under a reduced pressure to precipitate a water-insoluble black precipitate. This was filtered, washed with ion exchanged water, dissolved by adding 20 mL of a THF solution, and reprecipitated with methanol. The obtained powder was collected and dried. The UV-Vis spectrum of the THF solution of the obtained gold fine particles is shown in FIG. 1. Since the surface plasmon absorbance of the gold fine particles is observed at near 520 nm in the UV-Vis spectrum in FIG. 1, it is found that the gold fine particles are dispersed at a size in the order of nanometer.

Furthermore, the content of gold in the composition was obtained by an inductively coupled plasma atomic emission spectrometer (ICP-AES), and was consequently found to be 6.4 wt %.

In addition, the obtained gold fine particles were observed using a high-angle annular dark-field (HAADF) method by a scanning transmission electron microscope (STEM: JEM2100F, manufactured by HITACHI Ltd.). The resulted image is shown in FIG. 3. Furthermore, the result of the elemental analysis of the region shown by the arrow in FIG. 3 by an energy dispersive X-ray spectrometer (EDX) is shown in FIG. 4. From FIG. 4, it was found that a large amount of gold atoms is included in the region shown by the arrow having a strong contrast Furthermore, the branched polymer was observed at the region having a weak contrast. The image which was photographed for the same sample but at a different magnification ratio is shown in FIG. 5. Furthermore, the result of the elemental analysis of the region shown by the arrow in FIG. 5 by an energy dispersive X-ray spectrometer (EDX) is shown in FIG. 6. From FIG. 6, it was found that a large amount of gold atoms is included in the region shown by the arrow having a strong contrast. Furthermore, the branched polymer was observed at the region having a weak contrast. From these results, it was found that the branched polymer and gold fine particles formed a complex. It is considered that the dithiocarbamate group of the metal fine particle-dispersing agent adheres to the gold fine particles to form the complex.

Furthermore, in the complex composed of the branched polymer and the gold fine particles obtained in the present example, the average particle size of the surrounding metal nuclei (gold fine particles) was 2.8 nm.

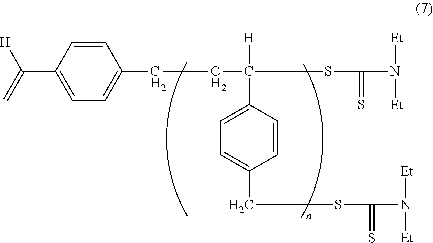

### Reference Example 3

### Synthesis of 1,2-Bis(N,N-diethyldithiocarbamyl)ethane EDC2

1,2-Dichloroethane, 109 g of sodium N,N-diethyldithiocarbamate trihydrate [manufactured by Kanto Chemical Co., Inc.] and 400 g of acetone were charged into a 1,000 mL reaction flask, and reacted at 40° C. for 18 hour under stirring. After the reaction, the precipitated sodium chloride was removed by filtration, and the acetone was then distilled off from the reaction solution using an evaporator to give a crude reaction powder. The crude reaction powder was dissolved again in toluene and separated in a toluene/water system, and the toluene was distilled off to give a white crude crystal. The crude crystal was recrystallized using 180 g of toluene to give 48 g of the objective white crystal (EDC2) (yield 75%). The purity (area percentage) by liquid chromatography was 99%.

### Reference Example 4

### Synthesis of Linear Polychloromethylstyrene LPS-Cl

20 g of chloromethylstyrene [manufactured by Seimi Chemical Co., Ltd., CMS-14 (trade name)], 20 g of toluene and 0.24 g of EDC2 synthesized in Reference Example 3 were charged into a 100 mL reaction flask, and the reaction system was purged with nitrogen. The solution was fixed on the position at a distance of 5 cm from a 100 W high pressure mercury lamp [HL-100, manufactured by Sen Lights Co., Ltd], and a photopolymerization reaction by external irradiation was carried out at room temperature for 5 hours under stirring. The conversion at that time was 20%. Dilution was carried out by adding 60 g of toluene, and the reaction liquid was purified by reprecipitation using 1,000 g of methanol and filtered under a reduced pressure to give a white solid. The obtained solid was dissolved again in 10 g of xylene, purified by reprecipitation using 1,000 g of methanol, filtered under a reduced pressure, and dried in vacuo to give 2.8 g of the objective LPS-Cl. Yield 14%.

### Reference Example 5

### Synthesis of Linear Polystyrene Having Dithiocarbamate Groups at Side Chains LPS

2.0 g of LPS-Cl which was synthesized in Reference Example 4, 4.0 g of sodium N,N-diethyldithiocarbamate trihydrate [manufactured by Kanto Chemical Co., Inc.] and 48 g of NMP were charged into a 100 mL reaction flask, and reacted at 40° C. for 18 hours under stirring. After the reaction, the NMP was distilled off from the reaction solution to give a crude reaction powder. The crude reaction powder was dissolved again in 20 g of toluene and separated with toluene/water, and the toluene was distilled off to give a white solid. The white solid was dissolved by using 20 g of toluene, purified by reprecipitation by using 600 g of methanol, filtered under a reduced pressure and dried in vacuo to give 3.2 g of the objective LPS. Yield 91%.

The weight average molecular weight Mw measured by polystyrene conversion by GPC was 35,000, and the degree of distribution Mw/Mn was 2.2. When the absolute molecular weight was measured, the weight average molecular weight Mw was 42,000. As an index for showing the degree of branching, a branching degree was defined as absolute molecular weight Mw/relative molecular weight Mw. The branching degree at that time was 1.20.

The viscosity was measured as follows. A uniform solution of 0.6 g of HPS and 0.9 g of toluene (40 mass % toluene solution) was prepared, and the viscosity was measured using a viscometer (VISCOMETER TV-22 TV-L, Told Sangyo Co., Ltd.) and found to be 95 mPa·s at a measurement temperature of 20° C.

### Example 2

### Preparation of Gold Fine Particles Using Linear Polymer

The preparation was carried out in a similar manner to Example 1, except that the linear polymer represented by the following formula (8) was used instead of the branched polymer represented by the formula (7) in Example 1. The UV-Vis spectrum of the THF solution of the obtained gold fine particles is shown in FIG. 2. From the UV-Vis spectrum of FIG. 2, since the surface plasmon absorbance of the gold fine particles is observed at near 520 nm as in FIG. 1, it is recognized that the gold fine particles are dispersed with the size at the order of nanometer.

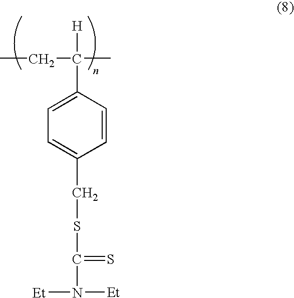

### Example 3

### Preparation of Silver Fine Particles Using Branched Polymer

The preparation was carried out in a similar manner to Example 1, except that silver nitrate was used instead of chloroauric acid in Example 1. The silver content in the composition was obtained by subjecting the obtained powder to ICP-AES and found to be 1.3 wt %. Furthermore, the average particle size of the metal nucleus of the resulted complex composed of the branched polymer and silver fine particles was 2.3 nm.

### Example 4

### Preparation of Palladium Fine Particles Using Branched Polymer

Pd(OAc)₂ (0.1 mmol, 24 mg) was put into a 20 mL Schlenk reaction tube and purged with nitrogen. THF (5 mL) was added thereto, and stirring was carried out for several minutes. Separately, methyltrioctylammonium chloride (0.05 mmol, 22 mg) was put into a two-necked flask (20 mL) and purged with nitrogen, then THF (5 mL) was added thereto, and the resulting solution was added dropwise to the Schlenk reaction tube. The system was purged with hydrogen and stirred at room temperature for 16 hours. Separately, the branched polymer represented by the formula (7) (0.2 mmol, 53.5 mg) was put into a two-necked flask (20 mL) and purged with hydrogen, then THF (5 mL) was added thereto, and the resulting solution was added dropwise to the Schlenk reaction tube, and stirring was carried out overnight at 60° C. Purification by reprecipitation was carried out by adding water degassed with argon (5 mL) to the reaction solution, and the precipitate was filtered and dried under a reduced pressure to give a black precipitate (42 mg). By observation using a transmission electron microscope (TEM: JEM2100F manufactured by JEOL Ltd.), the particle size of the palladium fine particles was found to be 5 nm. The result is shown in FIG. 7.

### Example 5

### Preparation of Platinum Fine Particles Using Branched Polymer

Pt(DBA)₂ (DBA: dibenzylideneacetone, 0.2 mmol, 132 mg) was put into a 20 mL Schlenk reaction tube and purged with nitrogen. THF (5 mL) was added thereto, and the mixture was stirred for several minutes. Separately, the branched polymer represented by the formula (7) (0.1 mmol, 26.5 mg) was put into a two-necked flask (20 mL) and purged with nitrogen, then THF (5 mL) was added thereto, and the resulting solution was added dropwise to the Schlenk reaction tube. The system was purged with hydrogen and stirred at room temperature for 16 hours. The reaction solution was purified by reprecipitation with methanol, filtered, and dried under reduced pressure to give a black precipitate (35 mg). From observation using a transmission electron microscope (TEM: JEM2100F manufactured by JEOL Ltd.), the particle size of the platinum fine particles was 2 nm.

### Example 6

### Mixing of Resin with Gold Fine Particles

A toluene solution in which 0.05 g of the gold fine particles obtained in Example 1 and 0.240 g of polystyrene [manufactured by Aldrich, MW: 280,000] had been dissolved so that the solid content concentration became 10% was spin-coated on a glass substrate at 300 rpm for 5 seconds and 2,500 rpm for 30 seconds. Drying was carried out by heating at 80° C. for 5 minutes. The mass of the gold in the composition was adjusted to 1.3 wt %.

The cross-sectional surface of the obtained polystyrene thin film was observed by a transmission electron microscope (TEM: H-8000 manufactured by HITACHI, Ltd.), and the result thereof is shown in FIG. 8.

### Comparative Example 1

Gold fine particles coated with dodecanethiol were prepared according to Non-patent Document 1. 80 mL of a 50 mM solution of tetraoctylammonium bromide in toluene was added to 30 mL of a 30 mM aqueous chloroauric acid solution. 170 mg of dodecanethiol was added thereto, the mixture was sufficiently stirred until the gold ion transferred to the toluene layer, and 25 mL of a 0.4 M aqueous sodium borohydride solution was added dropwise for about 5 minutes. The solution turned brown according to the dropwise addition. The toluene layer was separated, concentrated to about 2 mL and reprecipitated using 400 mL of ethanol. The obtained powder was collected and dried. The gold content in the composition was obtained by subjecting the obtained powder to ICP-AES, and found to be 67 wt %.

### Comparative Example 2

A toluene solution in which 0.005 g of the gold fine particles obtained in Comparative Example 1 and 0.245 g of polystyrene [manufactured by Aldrich, MW: 280,000] had been dissolved so that the solid content concentration became 1.0% was spin-coated on a glass substrate at 300 rpm for 5 seconds and 2,500 rpm for 30 seconds. Drying was carried out by heating at 80° C. for 5 minutes. The mass of the gold in the composition was adjusted to 1.3 wt %. The cross-sectional surface of the obtained polystyrene thin film is shown in FIG. 9.

Both thin films of Example 6 and Comparative Example 2 were colored brown and no significant difference in the appearance was confirmed. However, from the results of observation by a transmission electron microscope (TEM), it was observed that the gold fine particles were dispersed in the polystyrene in Example 6 (FIG. 8), whereas the gold fine particles were aggregated in Comparative Example 2 (FIG. 9). From these facts, it may be considered that the metal fine particles which are stabilized by a polymer having a dithiocarbamate group is excellent in dispersibility in a resin as compared to conventional metal fine particles protected with an alkanethiol.

Furthermore, the gold fine particles coated with dithiocarbamate group described in Non-patent Document 2 are those treated with CS₂ and tetra(N-methyl)aminomethylresorcinarene (TMAR) having an average particle size of 40 nm, whereas the metal nucleus of the gold-fine particle complex coated with the branched polymer having a dithiocarbamate group obtained in Example 1 had an average particle size of 2.8 nm. Therefore, the gold fine particles stabilized by the polymer having a dithiocarbamate group of the present invention have a much smaller particle size than that of the gold fine particles described in Non-patent Document 2. Since it is considered that metal nanoparticles having a particle size as in the present invention show a significant quantum size effect due to the size thereof, and exhibit specific physical and chemical properties which are not observed in bulks, the applications thereof may be expected.

### INDUSTRIAL APPLICABILITY

By using the metal fine particle-dispersing agent of the present invention, a metal fine particle complex having a small particle size could be obtained. Furthermore, the structure of the hyperbranched polymer having many end groups may be utilized by using the hyperbranched polymer as a metal fine particle-dispersing agent, and other functions may be provided by substituting a part of the end groups thereof with other functional groups. As a result, provision of a metal-fine particle complex having multiple properties will be enabled.

### BRIEF DESCRIPTION OF THE DRAWINGS

FIG. 1 is a UV-Vis spectrum of the gold fine particles obtained by Example 1.

FIG. 2 is a UV-Vis spectrum of the gold fine particles obtained by Example 2.

FIG. 3 is a STEM image of the gold fine particles obtained by Example 1.

FIG. 4 is the result of the elemental analysis of the region shown by the arrow in FIG. 3 using an energy dispersion type X-ray spectrometer.

FIG. 5 is a STEM image of the gold fine particles obtained by Example 1.

FIG. 6 is the result of elemental analysis of the region shown by the arrow in FIG. 5 using an energy dispersion type X-ray spectrometer.

FIG. 7 is a TEM image of the palladium fine particles obtained by Example 4.

FIG. 8 is a TEM image at the cross-sectional drawing of the gold fine particles obtained by Example 6 on the polystyrene thin film.

FIG. 9 is a TEM image at the cross-sectional drawing of the gold fine particles obtained by Comparative Example 2 on the polystyrene thin film.

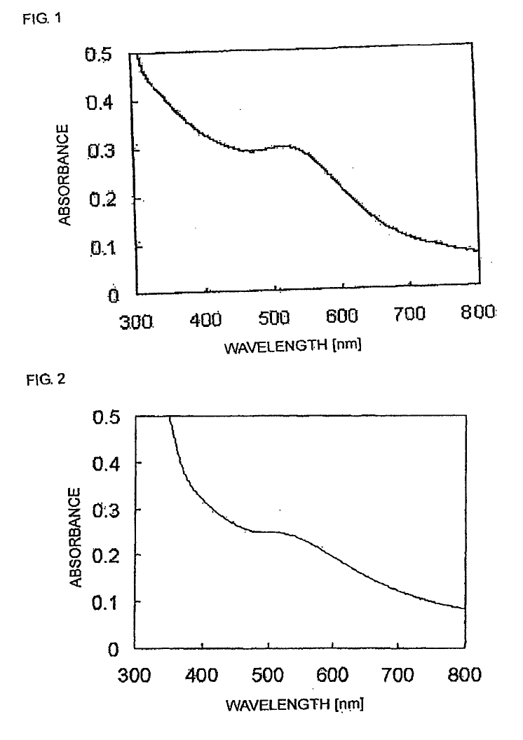

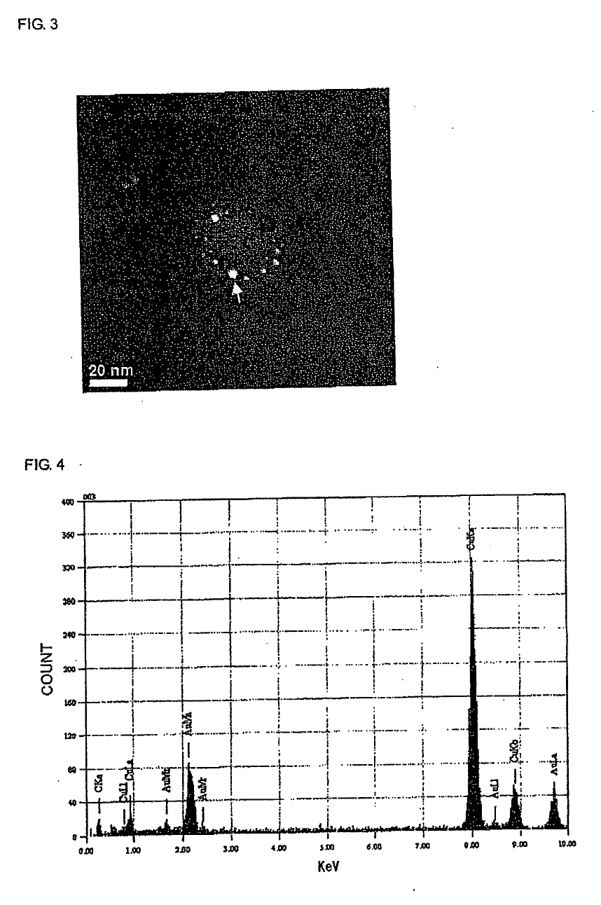

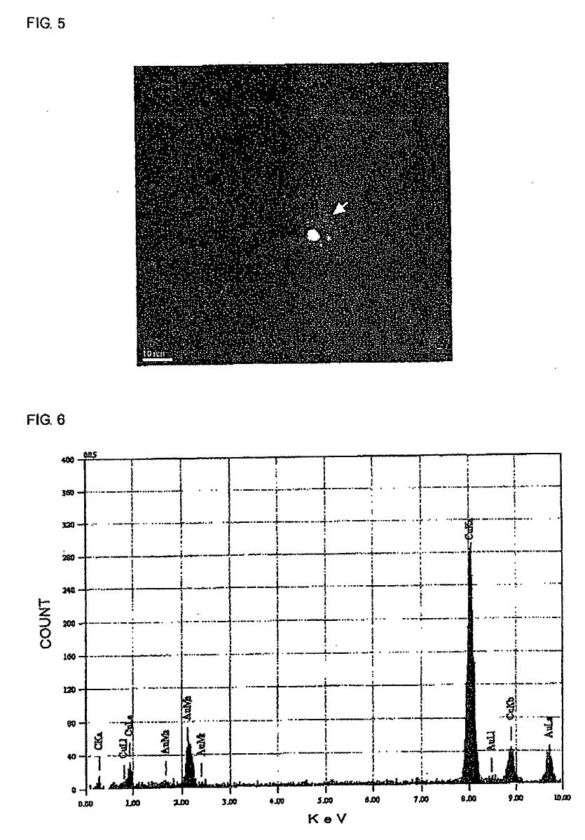

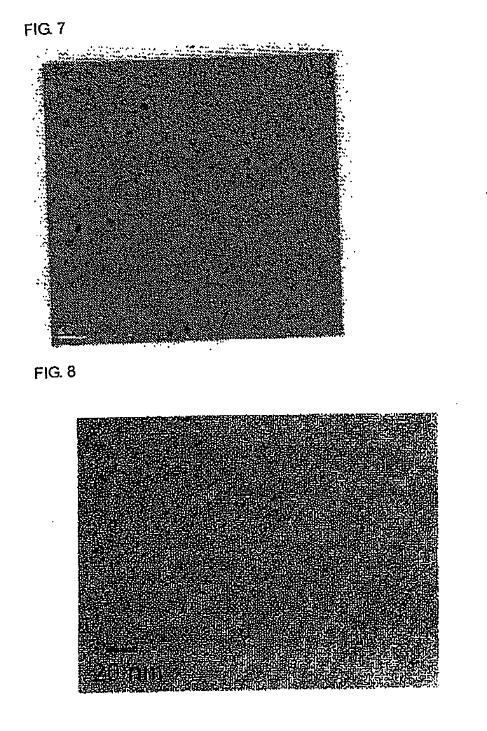

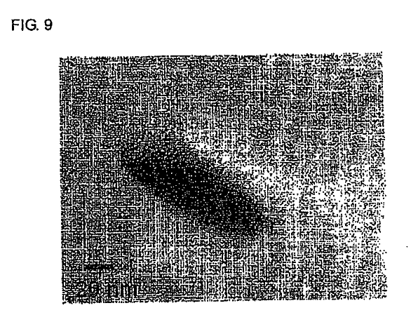

1. A metal fine particle-dispersing agent for forming a dispersion system of metal fine particles, comprising a branched and/or linear polymer compound having a dithiocarbamate group and having a weight average molecular weight of 500 to 5,000,000.

2. A composition comprising the metal fine particle-dispersing agent according to claim 1 and metal fine particles.

3. The composition according to claim 2, wherein the dithiocarbamate group of the metal fine particle-dispersing agent adheres to the metal fine particles to form a complex.

4. The composition according to claim 2, further comprising an organic solvent.

5. The composition according to claim 4, wherein the metal fine particles are dispersed in the organic solvent.

6. The composition according to claim 4, wherein the complex is dispersed in the organic solvent.

7. The composition according to claim 2, wherein the metal fine particles are at least one selected from the group consisting of scandium, titanium, vanadium, chromium, manganese, iron, cobalt, nickel, copper, zinc, gallium, germanium, yttrium, zirconium, niobium, molybdenum, ruthenium, rhodium, palladium, silver, cadmium, indium, tin, antimony, hafnium, tantalum, tungsten, rhenium, osmium, iridium, platinum, gold, mercury, thallium and bismuth.

8. The composition according to claim 7, wherein the metal fine particles are at least one selected from the group consisting of gold, silver, platinum, copper, nickel, ruthenium, rhodium, palladium, osmium and iridium.

9. The composition according to claim 8, wherein the metal fine particles are at least one selected from the group consisting of gold, silver, platinum and copper.

10. A thin film obtained from the composition according to claim 2.

11. The metal fine particle-dispersing agent according to claim 1, wherein the metal fine particle-dispersing agent is a branched polymer represented by the formula (1): 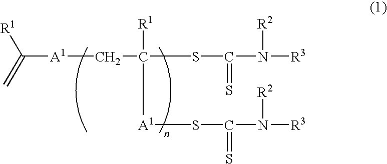
wherein
R¹ represents a hydrogen atom or a methyl group,
R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom,
A¹ represents the formula (2) or (3): 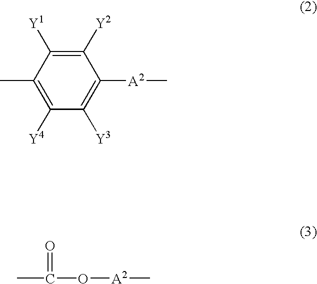
wherein
A² represents a linear, branched or cyclic alkylene group having 1 to 30 carbon atoms optionally containing an ether bond or an ester bond,
Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group, and
n represents the number of repeating unit structures and represents an integer of 2 to 100,000.

12. The metal fine particle-dispersing agent according to claim 1, wherein the metal fine particle-dispersing agent is a linear polymer represented by the formula (4): 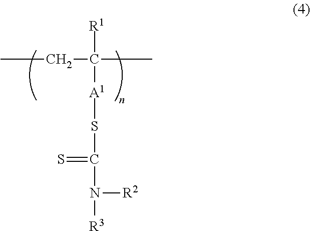
wherein
R¹ represents a hydrogen atom or a methyl group,
R² and R³ each represent an alkyl group having 1 to 5 carbon atoms, a hydroxyalkyl group having 1 to 5 carbon atoms or an arylalkyl group having 7 to 12 carbon atoms, or R² and R³ may bond to each other to form a ring together with a nitrogen atom,
A¹ represents the formula (5) or (6): 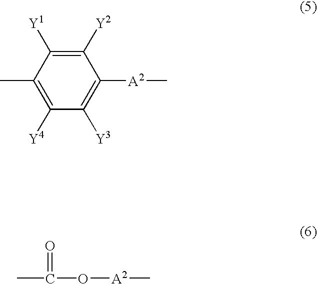
wherein
A² represents a linear, branched or cyclic alkylene group having 1 to 30 carbon atoms optionally containing an ether bond or an ester bond,
Y¹, Y², Y³ and Y⁴ each represent a hydrogen atom, an alkyl group having 1 to 20 carbon atoms, an alkoxy group having 1 to 20 carbon atoms, a halogen atom, a nitro group, a hydroxy group, an amino group, a carboxyl group or a cyano group, and
n represents the number of repeating unit structures and represents an integer of 2 to 100,000.

13. The composition according to claim 2, wherein the metal fine particle-dispersing agent is the branched polymer represented by the formula (1).

14. The composition according to claim 2, wherein the metal fine particle-dispersing agent is the linear polymer represented by the formula (4).

15. A method for producing the composition according to claim 2, comprising mixing the metal fine particle-dispersing agent with a metal salt, and reducing the metal salt in the mixture with a reducing agent.
